(19) United States
(12) Patent Application Publication
(10) Pub. No.: US 2018/0247103 A1
(43) Pub. Date: Aug. 30, 2018

(54) MECHANICAL PARKING GARAGE CONTROL SYSTEM

(71) Applicant: Primax Electronics Ltd., Taipei (TW)

(72) Inventors: MAO-HSIU HSU, Taipei (TW); KUAN-PAO TING, Taipei (TW)

(21) Appl. No.: 15/627,171

(22) Filed: Jun. 19, 2017

(30) Foreign Application Priority Data
Feb. 24, 2017 (TW) 106106451

(51) Int. Cl. G06K 9/00; E04H 6/12; E04H 6/42

(52) U.S. Cl. CPC G06K 9/00087; G06K 9/00013; G06K 2209/15; E04H 6/422; E04H 6/12

(57) ABSTRACT

The present invention provides a mechanical parking garage control system, configured to control storage and retrieval of a vehicle, and including: an identification apparatus, having a first camera module and a first fingerprint recognition module, where the first camera module is configured to capture a vehicle license plate image, and the first fingerprint recognition module is configured to capture fingerprint information; and a control apparatus, having a control module and a memory unit, wherein the control module identifies the vehicle license plate image to generate a vehicle license number and allocates a storage space to the vehicle according to the vehicle license number and the fingerprint information, and the memory unit is configured to store the vehicle license plate image, the vehicle license number, and the fingerprint information.

### FIELD OF THE INVENTION

The present invention relates to a mechanical parking garage control system, and in particular, to a multi-storey parking garage with functions of identification and automated parking and retrieval.

### BACKGROUND OF THE INVENTION

Taiwan is located on a long and narrow terrain with lots of hills and mountains. Particularly in metropolitan areas, land is scarce and expensive. With the development of economy, each family has at least one or two cars nowadays. In cities, it is usually difficult to occupy a parking space, and common people cannot afford to own a parking space. As cars proliferate, a conventional planar parking garage cannot meet requirements on parking spaces in the cities. A mechanical multi-storey parking garage may be built in a limited land area to provide a large number of parking spaces, to effectively resolve the problem of insufficient parking spaces. Therefore, mechanical multi-storey parking garages are increasingly populated in the cities, and common people are more willing to accept the mechanical multi-storey parking garages.

An existing mechanical multi-storey parking garage is common in a department store, a variety store, a restaurant, an office building, or a common apartment. People usually need to park or retrieve a vehicle by using a token or a magnetic card. If the token or the magnetic card is lost, the vehicle cannot be retrieved for the moment, and the expenses of compensation need to be paid for the token or the magnetic card. To resolve the problem of loss of the token or magnetic card, many parking garages start to replace the conventional token or magnetic card with a biometric recognition apparatus. For example, in a parking management system disclosed in US Patent No. US 20050033634A1, a personal fingerprint input apparatus and a fee charging system are disposed in each parking space. During parking, a fingerprint may be entered and stored in advance. During retrieval, the fingerprint is entered again for comparison and payment. Alternatively, for example, in a parking garage system disclosed in the Taiwan Patent No. TW 1363127, a control center is disposed. The control center identifies a driver or a vehicle, and distributes a parking space according to the identity of the driver or the identity of the vehicle. Although it is very convenient to park or retrieve a vehicle by means of fingerprint recognition, someone may perform a random unlock test on a fingerprint recognition apparatus by using fingerprint duplicates. Once the test succeeds, the vehicle may be easily stolen.

Therefore, how to improve security of a vehicle in a mechanical multi-storey parking garage while maintaining convenience for a vehicle owner in vehicle parking and retrieval is a technical problem to be resolved in the present invention.

### SUMMARY OF THE INVENTION

A main objective of the present invention is to provide a mechanical parking garage control system, to replace, with a fingerprint recognition system, a conventional manner in which a vehicle is retrieved by using a token or a magnetic card, so that the vehicle may be retrieved more conveniently. In addition, the fingerprint recognition system may work with a camera module to improve security of the vehicle.

To achieve the foregoing objective, the present invention provides a mechanical parking garage control system, configured to control storage and retrieval of a vehicle, and including:

an identification apparatus, having a first camera module and a first fingerprint recognition module, where the first camera module is configured to capture a vehicle license plate image of the vehicle, and the first fingerprint recognition module is configured to capture fingerprint information of a user; and

a control apparatus, having a control module and a memory unit, where

the control module identifies the vehicle license plate image of the vehicle to generate a vehicle license number, and allocates a storage space to the vehicle according to the vehicle license number and the fingerprint information of the user, and the memory unit is configured to store the vehicle license plate image and the vehicle license number of the vehicle, and the fingerprint information of the user.

In the foregoing preferred implementation manner, the mechanical parking garage control system includes a retrieving apparatus, where the retrieving apparatus has a second fingerprint recognition module and a man-machine interface, the man-machine interface is configured to enter the vehicle license number, the second fingerprint recognition module is configured to collect the fingerprint information of the user, and the control module performs comparison based on the vehicle license number entered by using the man-machine interface and the fingerprint information of the user collected by the second fingerprint recognition module, to determine whether to retrieve the vehicle from the storage space.

In the foregoing preferred implementation manner, the retrieving apparatus further includes a second camera module, where when the fingerprint information of the user collected by the second fingerprint recognition module is inconsistent with the fingerprint information of the user collected by the first fingerprint recognition module, the control apparatus drives the second camera module to capture an image of the user.

In the foregoing preferred implementation manner, the man-machine interface is a touchscreen, a keyboard, or a voice-control module.

In the foregoing preferred implementation manner, the control apparatus is a server.

In the foregoing preferred implementation manner, the first fingerprint recognition module is an optical fingerprint recognition module, a capacitive fingerprint recognition module, or a pressure-sensitive fingerprint recognition module.

In the foregoing preferred implementation manner, the second fingerprint recognition module is an optical fingerprint recognition module, a capacitive fingerprint recognition module, or a pressure-sensitive fingerprint recognition module.

### BRIEF DESCRIPTION OF THE DRAWINGS

FIG. 1 is a mechanical parking garage control system according to the present invention;

FIG. 2A to FIG. 2C are a schematic diagram of vehicle storage according to the present invention; and

FIG. 3 is a schematic diagram of vehicle retrieval according to the present invention.

### DETAILED DESCRIPTION OF THE PREFERRED EMBODIMENT

The advantages and features of the present invention and the method for implementing the same are more readily understood with reference to the following detailed description of preferred embodiments and accompanying drawings. However, the present invention may be implemented in different forms, and should not be understood as being limited to the embodiments set forth herein. Rather, for a person of ordinary skill in the art, these embodiments are provided so that this disclosure will be more thorough and comprehensive, and will fully convey the concept of the present invention.

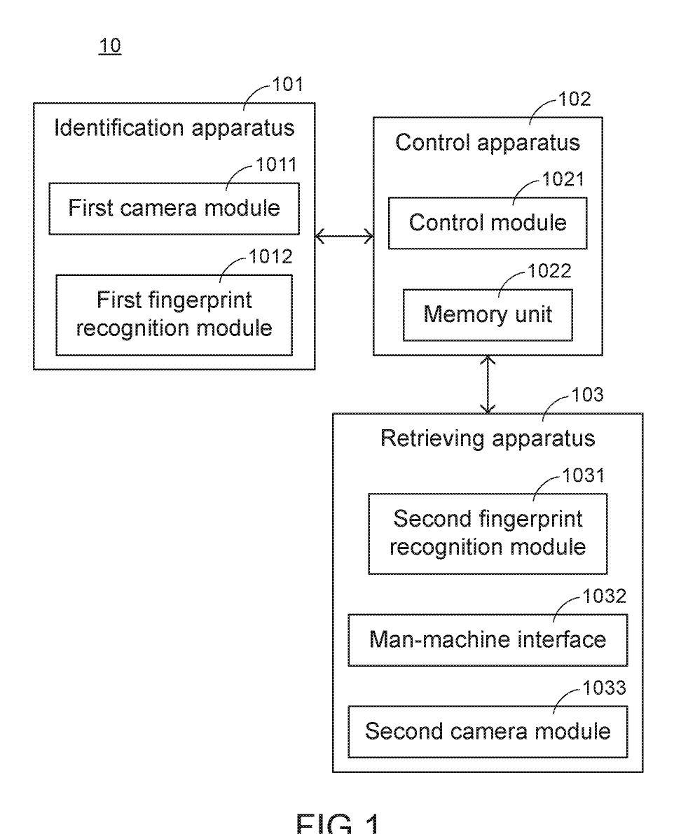

First, referring to FIG. 1, FIG. 1 is a mechanical parking garage control system according to the present invention. In FIG. 1, the mechanical parking garage control system 10 includes an identification apparatus 101, a control apparatus 102, and a retrieving apparatus 103. The identification apparatus 101 has a first camera module 1011 and a first fingerprint recognition module 1012. The control apparatus 102 has a control module 1021 and a memory unit 1022, and the control apparatus 102 is a server having a wireless or wired connection function. The retrieving apparatus 103 has a second fingerprint recognition module 1031, a man-machine interface 1032, and a second camera module 1033. The man-machine interface 1032 may be a touchscreen, a keyboard, or a voice-control module. The control apparatus 102 may send information to or receive information from the identification apparatus 101 and the retrieving apparatus 103 in a wired or wireless manner. The first fingerprint recognition module 1012 and the second fingerprint recognition module 1031 of the present invention may be optical fingerprint recognition modules, capacitive fingerprint recognition modules, or pressure-sensitive fingerprint recognition modules.

When a vehicle is to enter a mechanical parking garage, first, a vehicle license plate image of the vehicle is captured by the first camera module 1011, and fingerprint information of a user is collected by the first fingerprint recognition module 1012. Then, the identification apparatus 101 may transmit the vehicle license plate image of the vehicle and the fingerprint information of the user to the control apparatus 102 in a wired or wireless manner. The control module 1021 in the control apparatus 102 identifies the vehicle license plate image of the vehicle to generate a vehicle license number. Then, the control module 1021 allocates a storage space to the vehicle according to the generated vehicle license number and the fingerprint information of the user. After the vehicle enters the mechanical parking garage, the vehicle is stored in the allocated storage space by using a hoisting apparatus. Then, the control module 1021 stores, in the memory unit 1022, the vehicle license plate image and the vehicle license number of the vehicle, and the fingerprint information of the user that is collected by the first fingerprint recognition module 1012.

When the user is to retrieve the vehicle, first, the vehicle license number is entered by using the man-machine interface 1032 in the retrieving apparatus 103, and then the fingerprint information of the user is collected by the second fingerprint recognition module 1031. Then, the retrieving apparatus 103 transmits, to the control apparatus 102 in a wired or wireless manner, the vehicle license number entered by using the man-machine interface 1032 and the fingerprint information of the user collected by the second fingerprint recognition module 1031 for comparison. After determining that the received vehicle license number information is correct, the control module 1021 in the control apparatus 102 further compares the fingerprint information of the user collected by the first fingerprint recognition module 1012 and stored in the memory unit 1022 with the fingerprint information of the user collected by the second fingerprint recognition module 1031. If the fingerprint information of the user collected by the first fingerprint recognition module 1012 is consistent with the fingerprint information of the user collected by the second fingerprint recognition module 1031, the control apparatus 102 drives the hoisting apparatus to move the vehicle out of the storage space, so that the user may drive the vehicle out of the mechanical parking garage. The vehicle license plate image, the vehicle license number, and the fingerprint information in the memory unit 1022 are immediately deleted or are deleted after a preset period of time. If the fingerprint information of the user collected by the first fingerprint recognition module 1012 is inconsistent with the fingerprint information of the user collected by the second fingerprint recognition module 1031, the control apparatus 102 drives the second camera module 1033 in the retrieving apparatus 103 to capture an image of the user and starts an alarm (not shown in the figure) to make warning and deterring. In addition, the control apparatus 102 may further send, in a wired or wireless manner, the image of the user captured by the second camera module 1033 to a security system or an online police system. In this case, the security system or the online police system may know timely according to the image of the user captured by the second camera module 1033 that there may be an unidentified person in the mechanical parking garage meaning to steal or move the vehicle.

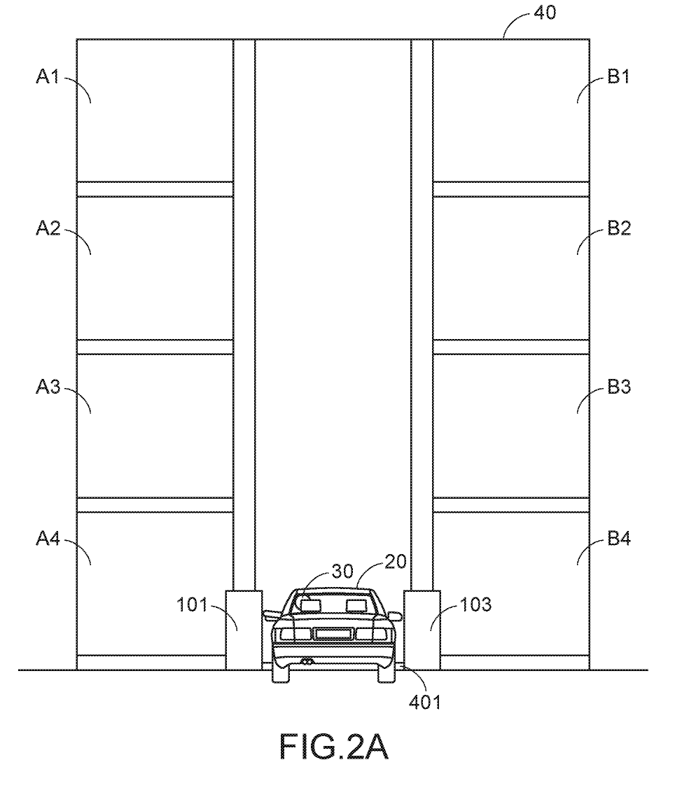

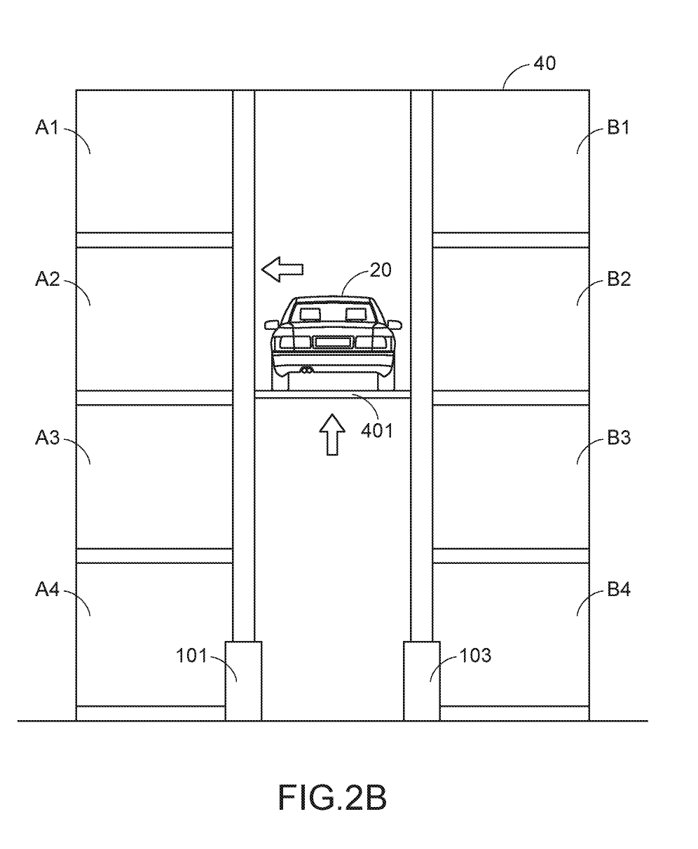

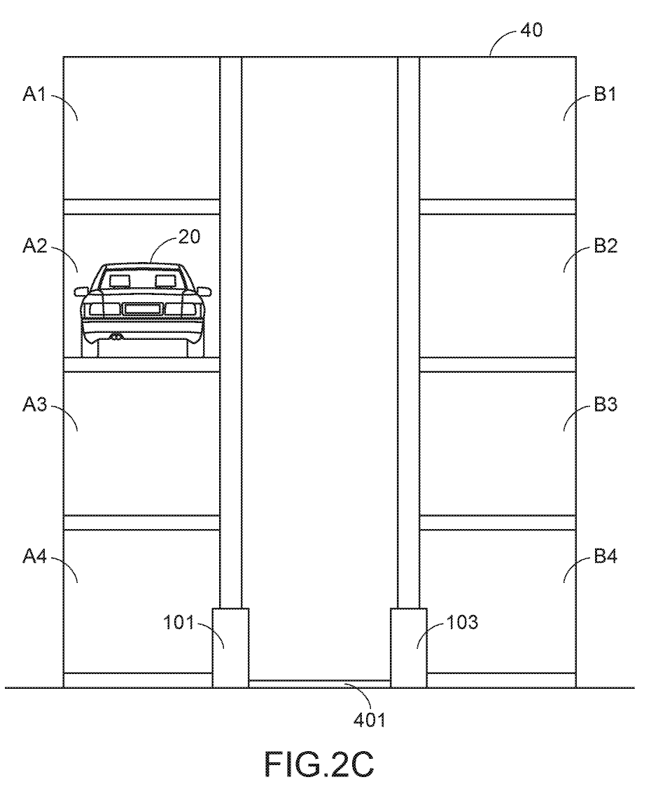

Further referring to FIG. 1 and FIG. 2A to FIG. 2C, FIG. 2A to FIG. 2C are a schematic diagram of vehicle storage according to the present invention. In FIG. 2A, a mechanical parking garage 40 has an identification apparatus 101, a retrieving apparatus 103, storage spaces A1 to A4 and B1 to B4, and the like. When a user 30 drives a vehicle 20 to enter the mechanical parking garage 40, the identification apparatus 101 uses a first camera module 1011 to capture a vehicle license plate image of the vehicle 20, and uses a first fingerprint recognition module 1012 to collect fingerprint information of the user 30, and then transmits the vehicle license plate image of the vehicle 20 and the fingerprint information of the user 30 to a control apparatus 102 in a wired or wireless manner. A control module 1021 in the control apparatus 102 identifies the vehicle license plate image of the vehicle 20 to generate a vehicle license number, and the control module 1021 allocates any one of the storage spaces A1 to A4 or B1 to B4 to the vehicle 20 according to the vehicle license number and the fingerprint information of the user 30.

Further referring to FIG. 2B and FIG. 2C, after the vehicle 20 enters the mechanical parking garage 40, a hoisting apparatus 401 is started to lift the vehicle 20 and store the vehicle 20 in the allocated storage space A2. Then, the control module 1021 stores, in the memory unit 1022, the vehicle license plate image and the vehicle license number of the vehicle 20, and the fingerprint information of the user 30 that is collected by the first fingerprint recognition module 1012.

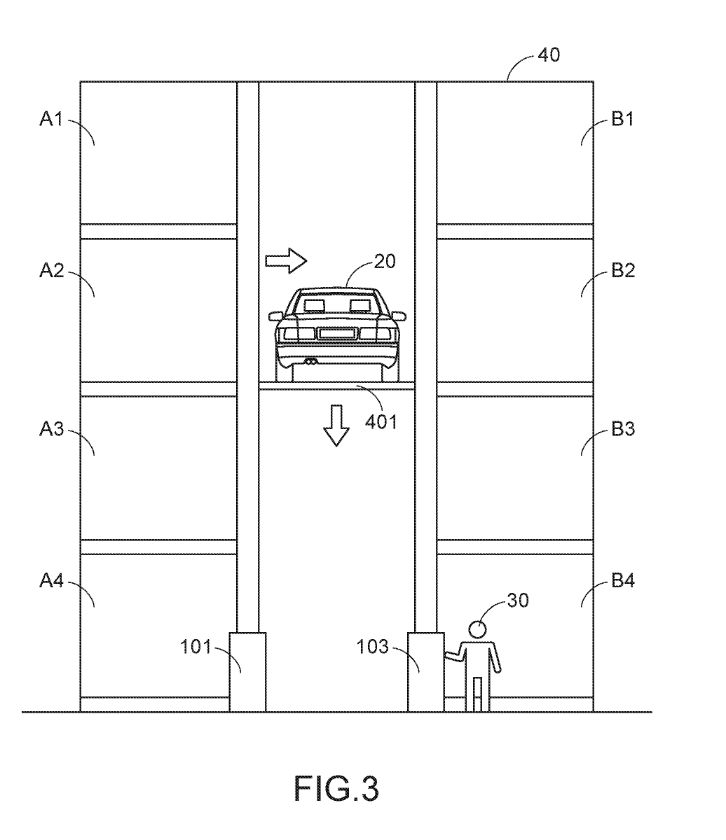

Then, referring to FIG. 1 and FIG. 3, FIG. 3 is a schematic diagram of vehicle retrieval according to the present invention. In FIG. 3, when the user 30 is to retrieve the vehicle 20, first, the vehicle license number of the vehicle 20 is entered by using a man-machine interface 1032 in the retrieving apparatus 103, and then the fingerprint information of the user 30 is collected by a second fingerprint recognition module 1031. Then, the retrieving apparatus 103 transmits, to the control apparatus 102 in a wired or wireless manner, the vehicle license number entered by using the man-machine interface 1032 and the fingerprint information of the user 30 collected by the second fingerprint recognition module 1031. After determining that the vehicle license number of the vehicle 20 is correct, the control module 1021 in the control apparatus 102 further compares the fingerprint information of the user 30 collected by the first fingerprint recognition module 1012 and stored in the memory unit 1022 with the fingerprint information of the user 30 collected by the second fingerprint recognition module 1031. If the fingerprint information of the user 30 collected by the first fingerprint recognition module 1012 is consistent with the fingerprint information of the user 30 collected by the second fingerprint recognition module 1031, after the user 30 completes a payment process, the control apparatus 102 drives the hoisting apparatus 401 to move the vehicle 20 out of the storage space A2, so that the user 30 may drive the vehicle 20 out of the mechanical parking garage 40. If the fingerprint information of the user 30 collected by the first fingerprint recognition module 1012 is inconsistent with the fingerprint information of the user 30 collected by the second fingerprint recognition module 1031, the control apparatus 102 drives the second camera module 1033 in the retrieving apparatus 103 to capture an image of the user 30 and starts an alarm (not shown in the figures) to make warning and deterring.

In addition, the control apparatus 102 may send, in a wired or wireless manner, the image of the user 30 captured by the second camera module 1033 to a security system or an online police system. In this case, the security system or the online police system may know timely according to the image of the user 30 captured by the second camera module 1033 that there may be an unidentified person in the mechanical parking garage 40 meaning to steal or move the vehicle 20. Although the present invention provides only the implementation manner in which the identification apparatus 101 and the retrieving apparatus 103 are separately disposed, during actual application, the identification apparatus 101 and the retrieving apparatus 103 may be combined as a single apparatus according to locations of an exit and an entrance of the mechanical parking garage 40. The combined single apparatus may share a fingerprint recognition module and a camera module, so that costs of system configuration of the present invention may be reduced.

Compared with the prior art, the present invention replaces, with a fingerprint recognition module, a conventional manner in which a vehicle is retrieved in a sensing manner by using a token or a magnetic card. Costs of the token, the magnetic card, and a device for reading the same are reduced, and a user is freed from worrying that the vehicle cannot be retrieved due to loss of the token or the magnetic card. In addition, by means of a camera module in combination with the fingerprint recognition module, not only can the user quickly park, but also when a suspicious person means to retrieve or move the vehicle, an image of the suspicious person may also be captured and uploaded by the camera module, so that a security system or an online police system may immediately know the situation. In this way, the present invention provides both convenience and vehicle security. Therefore, the present invention is essentially of high industrial value.

Any modification to the present invention readily figured out by a person skilled in the art shall fall within the protection scope of the appended claims.

What is claimed is:

1. A mechanical parking garage control system, configured to control storage and retrieval of a vehicle, and comprising:
an identification apparatus, having a first camera module and a first fingerprint recognition module, wherein the first camera module is configured to capture a vehicle license plate image of the vehicle, and the first fingerprint recognition module is configured to capture fingerprint information of a user; and
a control apparatus, having a control module and a memory unit, wherein
the control module identifies the vehicle license plate image of the vehicle to generate a vehicle license number, and allocates a storage space to the vehicle according to the vehicle license number and the fingerprint information of the user, and the memory unit is configured to store the vehicle license plate image and the vehicle license number of the vehicle, and the fingerprint information of the user.

2. The mechanical parking garage control system according to claim 1, comprising a retrieving apparatus, wherein the retrieving apparatus has a second fingerprint recognition module and a man-machine interface, the man-machine interface is configured to enter the vehicle license number, the second fingerprint recognition module is configured to collect the fingerprint information of the user, and the control module performs comparison based on the vehicle license number entered by using the man-machine interface and the fingerprint information of the user collected by the second fingerprint recognition module, to determine whether to retrieve the vehicle from the storage space.

3. The mechanical parking garage control system according to claim 2, wherein the retrieving apparatus further comprises a second camera module, wherein when the fingerprint information of the user collected by the second fingerprint recognition module is inconsistent with the fingerprint information of the user collected by the first fingerprint recognition module, the control apparatus drives the second camera module to capture an image of the user.

4. The mechanical parking garage control system according to claim 2, wherein the man-machine interface is a touchscreen, a keyboard, or a voice-control module.

5. The mechanical parking garage control system according to claim 1, wherein the control apparatus is a server.

6. The mechanical parking garage control system according to claim 1, wherein the first fingerprint recognition module is an optical fingerprint recognition module, a capacitive fingerprint recognition module, or a pressure-sensitive fingerprint recognition module.

7. The mechanical parking garage control system according to claim 2, wherein the second fingerprint recognition module is an optical fingerprint recognition module, a capacitive fingerprint recognition module, or a pressure-sensitive fingerprint recognition module.
